(19) United States
(12) Patent Application Publication
(10) Pub. No.: US 2012/0087630 A1
(43) Pub. Date: Apr. 12, 2012

(54) APPARATUS AND METHOD FOR DYNAMICALLY ADJUSTING IMAGE

(75) Inventor: PANG-WEI HSU, TAIPEI CITY (TW)

(73) Assignee: MICRO-STAR INT'L CO., LTD., NEW TAIPEI CITY (TW)

(21) Appl. No.: 13/083,677

(22) Filed: Apr. 11, 2011

(30) Foreign Application Priority Data
Oct. 6, 2010 (TW) 099134109

(51) Int. Cl. H04N 5/775; G09G 5/02

(52) U.S. Cl. 386/230; 345/589; 386/E05.07

(57) ABSTRACT

An apparatus and a method for dynamically adjusting an image are disclosed. The apparatus for dynamically adjusting the image includes a capturing unit, an optimum curve generating unit, a storage unit and an adjusting unit. The capturing unit captures a current frame on a display, and the storage unit stores reference curves. The optimum curve generating unit chooses one of the reference curves as an optimum curve according to the current frame, and the adjusting unit adjusts a gamma setting value of the display according to the optimum curve.

This application claims the benefit of Taiwan application Serial No. 99134109, filed Oct. 6, 2010, the subject matter of which is incorporated herein by reference.

### BACKGROUND OF THE INVENTION

1. Field of the Invention

The invention relates in general to an apparatus and a method for adjusting an image, and more particularly to an apparatus and a method for dynamically adjusting an image.

2. Description of the Related Art

With the technology, which is changing with each passing day, various displays have been gradually applied to various electronic devices, such as a computer, a mobile phone and a media player. In order to seek for the better display quality, a processor has to perform image adjusting on each pixel before the video signal is outputted to the display, and then the adjusted pixels are outputted to the display.

However, performing the image adjusting on each pixel by the processor occupies too many resources of the processor. More particularly, the resources of the processor in a handheld electronic device are very precious. Thus, the conventional image adjusting method is not suitable for the handheld electronic device. In addition, the conventional image adjusting method has to be designed according to the operation system or driver. Once the operation system or driver is upgraded, the image adjusting function cannot be supported any more. In addition, the conventional image adjusting method further has to be designed according to different video players. For example, one image adjusting method has to be provided for the static video player, and another different image adjusting method has to be provided for the dynamic video player.

### SUMMARY OF THE INVENTION

The invention is directed to an apparatus and a method for dynamically adjusting an image, wherein the apparatus and the method dynamically adjust a gamma setting value of a display according to a current frame on the display.

According to a first aspect of the present invention, a method for dynamically adjusting an image is provided. The method includes the following steps. First, a current frame displayed on a display is captured. Next, one of a plurality of reference curves is chosen as an optimum curve according to the current frame. Then, a gamma setting value of the display is adjusted according to the optimum curve.

According to a second aspect of the present invention, an apparatus for dynamically adjusting an image is provided. The apparatus includes a capturing unit, an optimum curve generating unit, a storage unit and an adjusting unit. The capturing unit captures a current frame displayed on a display. The optimum curve generating unit chooses one of a plurality of reference curves as an optimum curve according to the current frame. The storage unit stores the reference curves. The adjusting unit adjusts a gamma setting value of the display according to the optimum curve.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flow chart showing a method for dynamically adjusting an image according to a first embodiment.

FIG. 2 is a block diagram showing an apparatus for dynamically adjusting the image according to the first embodiment.

FIG. 3 is a schematic illustration showing a gray-scale distribution of a current frame.

FIG. 4 is a schematic illustration showing an optimum curve.

FIG. 5 is a flow chart showing a method for dynamically adjusting an image according to a second embodiment.

FIG. 6 is a block diagram showing an apparatus for dynamically adjusting the image according to the second embodiment.

FIG. 7 is a schematic illustration showing a file content of a first video player.

FIG. 8 is a schematic illustration showing a file content of a second video player.

### DETAILED DESCRIPTION OF THE INVENTION

In order to enhance the display quality, several apparatuses and methods for dynamically adjusting images will be disclosed in the following embodiments. The method for dynamically adjusting the image includes the following steps. First, a current frame displayed on a display is captured. Next, one of a plurality of reference curves is chosen as an optimum curve according to the current frame. Then, a gamma setting value of the display is adjusted according to the optimum curve.

The apparatus for dynamically adjusting an image includes a capturing unit, an optimum curve generating unit, a storage unit and an adjusting unit. The capturing unit captures a current frame displayed on a display. The optimum curve generating unit chooses one of a plurality of reference curves as an optimum curve according to the current frame. The storage unit stores the reference curves, and the adjusting unit adjusts a gamma setting value of the display according to the optimum curve.

### First Embodiment

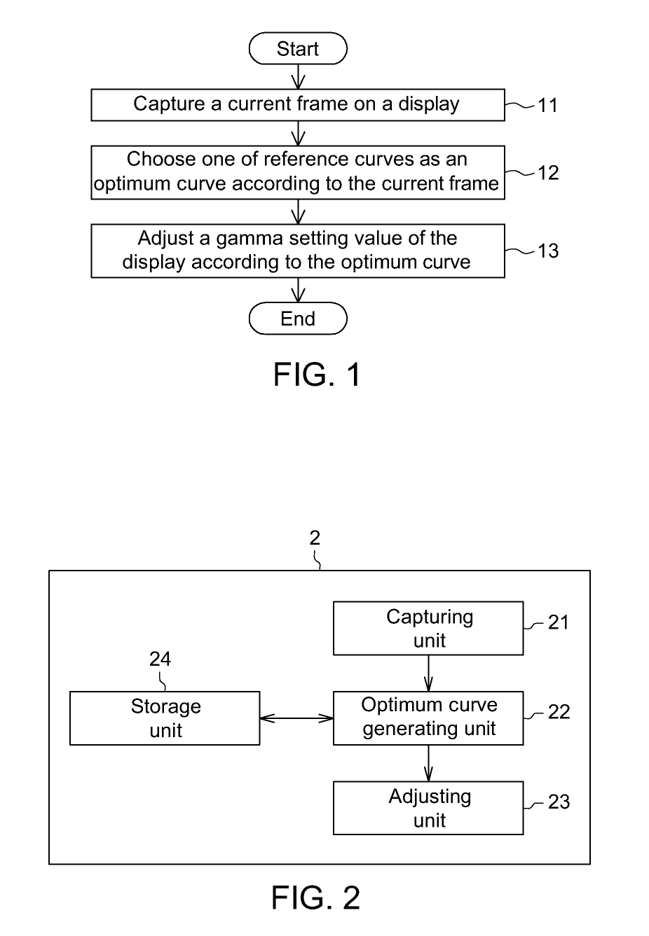

FIG. 1 is a flow chart showing a method for dynamically adjusting an image according to a first embodiment. FIG. 2 is a block diagram showing an apparatus 2 for dynamically adjusting the image according to the first embodiment. Referring to FIGS. 1 and 2, the apparatus 2 and the method can be widely used in various electronic devices, such as computers, mobile phones or media players, having displays. The apparatus 2 includes a capturing unit 21, an optimum curve generating unit 22, an adjusting unit 23 and a storage unit 24, which stores a plurality of reference curves. The capturing unit 21, the optimum curve generating unit 22 and the adjusting unit 23 are implemented by a processor executing software, for example. The apparatus 2 can perform the method for dynamically adjusting the image, and the method includes steps 11 to 13. First, as shown in the step 11, the capturing unit 21 captures a current frame, displayed on a display. It is to be specified that the capturing unit 21 may capture the current frame, displayed on the display, through various aspects, which do not intend to restrict the invention. For example, the capturing unit 21 may capture the current frame through the Microsoft's graphical device interface (GDI), DirectX or media application program interface (Media API).

The conventional method for adjusting the image has to obtain the information of the video source so that the subsequent adjusting process can be performed. So, the conventional method has to be designed according to the operation system or the driver. Once the operation system or driver is upgraded, the image adjusting function cannot be supported any more, and the frame quality cannot be improved. In addition, the conventional image adjusting method has to be designed according to different video players due to different video sources. For example, one image adjusting method has to be provided for a static video player, and another different image adjusting method has to be provided for a dynamic video player.

Different from the conventional image adjusting method, this embodiment captures the current frame, displayed on the display, for the subsequent image adjustment. Consequently, whether the operation system or driver is upgraded will not affect the image adjusting function, supported by this embodiment, so that the frame quality can be effectively improved. In addition, this embodiment captures the current frame, displayed on the display, for the subsequent image adjustment, and thus can be directly applied to various video players. Thus, it is unnecessary to design the image adjusting method according to different video players.

After the step 11 is finished, the step 12 is performed. As shown in the step 12, the optimum curve generating unit 22 chooses one of the reference curves as an optimum curve according to the current frame. The reference curves may be generated according to a high dynamic range (HDR) algorithm or a histogram equalization algorithm, and the reference curves may be further respectively built into several look-up tables to increase the image processing speed.

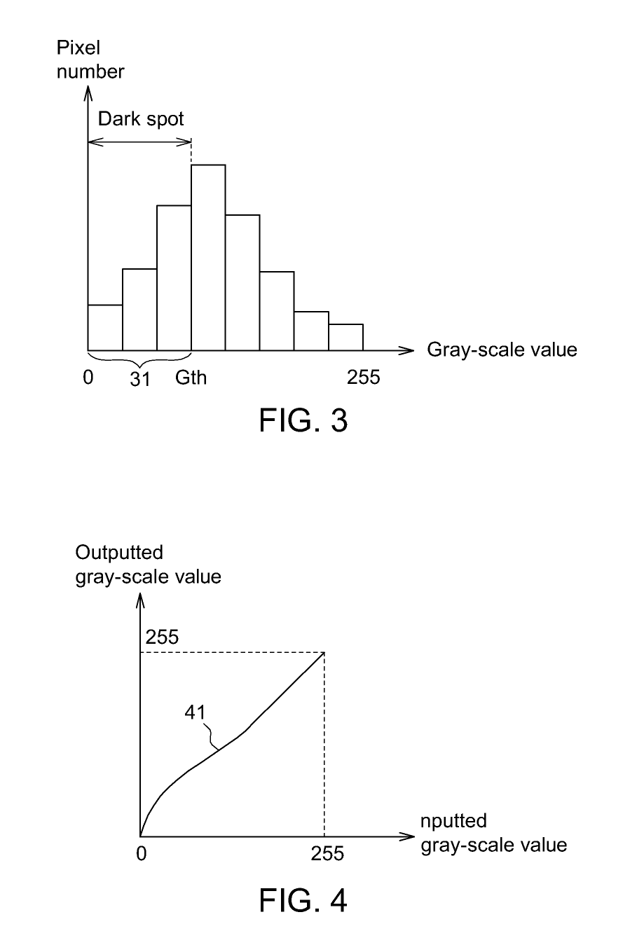

FIG. 3 is a schematic illustration showing a gray-scale distribution of the current frame. FIG. 4 is a schematic illustration showing an optimum curve. It is to be noted that FIGS. 3 and 4 are only for the illustrative purpose and do not intend to restrict the process of determining the gray-scale threshold value Gth. In fact, the gray-scale threshold value Gth may be set as an arbitrary value according to the actual application.

For example, the gray-scale distribution of the current frame is shown in FIG. 3. The gray-scale values 0 to 255 may be further divided into 8 equal portions. The minimum three equal portions of the gray-scale values are defined as a dark spot area 31, so that the gray-scale threshold value Gth can be determined. In the example of FIG. 3, the gray-scale threshold value Gth is equal to 96. If the gray-scale value of the pixel in the current frame is smaller than the gray-scale threshold value Gth, the pixel is defined as a dark spot and falls into one of three equal portions of the dark spot area 31 in the statistics. The number of pixels in the dark spot area 31 is the total number of the dark spots. The ratio of the number of the dark spots to the number of the total pixels is referred to as a dark-spot ratio. Different dark-spot ratios correspond to different reference curves. The optimum curve generating unit 22 can choose a corresponding one of reference curves as the optimum curve 41 of FIG. 4 according to the dark-spot ratio of the current frame.

After the step 12 is finished, the step 13 is performed. As shown in step 13, the adjusting unit 23 adjusts the gamma setting value of the display, such as a gamma ramp value, according to the optimum curve. It is to be specified that the adjusting unit 23 may adjust the gamma setting value of the display according to the optimum curve in many aspects, which do not intend to restrict the scope of this invention. For example, the adjusting unit 23 adjusts the gamma setting value of the display through Microsoft's graphical device interface (GDI) or DirectX, and thus achieves the effect of properly adjusting the brightness, contrast or color saturation of the frame.

In the conventional image adjusting method, the processor performs processing and adjusting processes on each pixel and then outputs the adjusted and processed results to the display. So, a lot of resources of the processor are occupied. Different from the conventional image adjusting method, this embodiment directly adjusts the gamma setting value of the display, and thus greatly reduces the operation works of the processor. It is to be specified that, in the handheld electronic device, the resources of the processor are very precious. Because the conventional image adjusting method significantly wastes the resources of the processor, it is not suitable for the handheld electronic device. Oppositely, this embodiment cannot occupy too many resources of the processor, and is quite suitable for the application of the handheld electronic device. Furthermore, even if the original video source has the poor frame quality, the display can display the better frame quality through the image adjustment of the embodiment.

### Second Embodiment

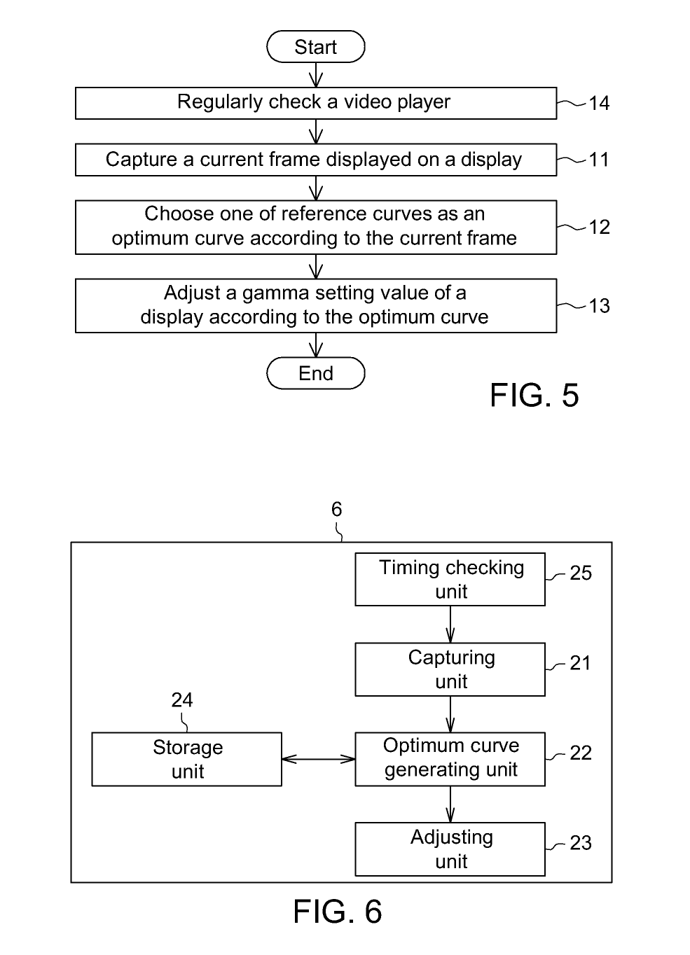

Please refer to FIGS. 5 and 6. FIG. 5 is a flow chart showing a method for dynamically adjusting an image according to a second embodiment. FIG. 6 is a block diagram showing an apparatus 6 for dynamically adjusting the image according to the second embodiment. In addition to the capturing unit 21, the optimum curve generating unit 22, the adjusting unit 23 and the storage unit 24, the apparatus 6 further includes a timing checking unit 25. In addition to the steps 11 to 13, the method for dynamically adjusting the image according to the second embodiment further includes a step 14, which is performed before the step 11. As shown in the step 14, the timing checking unit 25 regularly checks whether the video player is executed, and does not perform the steps 11 to 13 until the video player is executed. The video player may be, for example, a static video player or a dynamic video player.

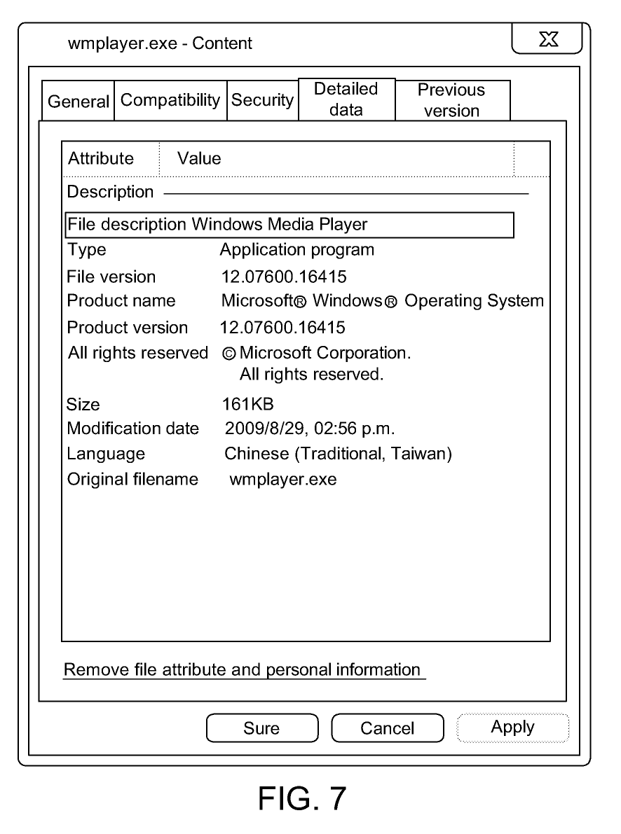

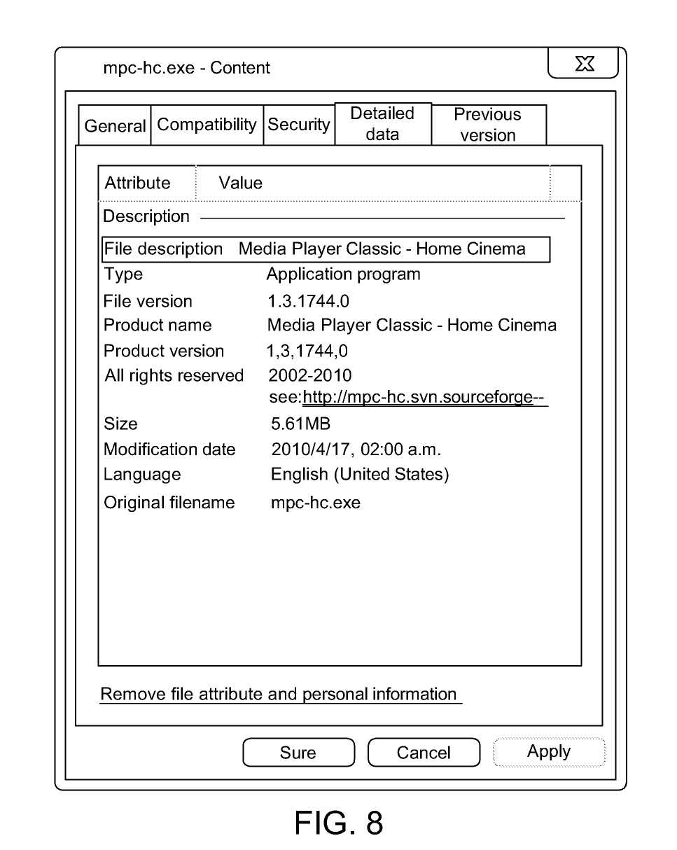

Please refer to FIGS. 7 and 8. FIG. 7 is a schematic illustration showing a file content of a first video player. FIG. 8 is a schematic illustration showing a file content of a second video player. When the timing checking unit 25 regularly checks the video player, it checks the file description in the file content of the video player, for example. If the file description appears the associated words “Media Player”, the processing is performed through the associated Microsoft's API. Consequently, the steps 11 to 13 can be performed only in the condition that the video player is executed.

The aspect of checking the video player has been disclosed but is not restricted thereto. The method of checking the video player may also be performed through Microsoft's Hook technique or by checking the entity for executing the application program. Furthermore, the object of checking the video player may also be achieved by creating a table, looking up the registry table or window searching.

Although several embodiments of the invention have been described, any technique is still deemed as falling within the scope of the invention as long as it is performed by capturing the current frame displayed on the display, thus choosing one of reference curves as an optimum curve, and adjusting the gamma setting value of the display according to the optimum curve.

The apparatus and method for dynamically the images according to the invention have many advantages, some of which will be listed in the following.

First, the occupied resources of the processor are decreased.

Second, the method for adjusting the image needs not to be re-designed in response to the updating of the operation system and the driver.

Third, it is unnecessary to design different method for adjusting images in response to different video players.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for dynamically adjusting an image, the method comprising the steps of:
capturing a current frame displayed on a display;
choosing one of a plurality of reference curves as an optimum curve according to the current frame; and
adjusting a gamma setting value of the display according to the optimum curve.

2. The method according to claim 1, further comprising the step of:
regularly checking a video player,
wherein the steps of capturing, choosing and adjusting are performed when the video player is executed.

3. The method according to claim 1, wherein the step of choosing chooses one of the reference curves as the optimum curve according to a dark-spot ratio of the current frame.

4. The method according to claim 1, wherein the reference curves are respectively built into a plurality of look-up tables.

5. The method according to claim 1, wherein the reference curves are generated according to a high dynamic range (HDR) algorithm.

6. The method according to claim 1, wherein the reference curves are generated according to a histogram equalization algorithm.

7. The method according to claim 1, wherein the step of capturing captures the current frame through a graphical device interface (GDI).

8. The method according to claim 1, wherein the step of capturing captures the current frame through DirectX.

9. The method according to claim 1, wherein the step of capturing captures the current frame through a media application program interface (Media API).

10. The method according to claim 1, wherein the step of adjusting adjusts the gamma setting value through a graphical device interface (GDI).

11. The method according to claim 1, wherein the step of adjusting adjusts the gamma setting value through DirectX.

12. An apparatus for dynamically adjusting an image, the apparatus comprising:
a capturing unit for capturing a current frame displayed on a display;
an optimum curve generating unit for choosing one of a plurality of reference curves as an optimum curve according to the current frame;
a storage unit for storing the reference curves; and
an adjusting unit for adjusting a gamma setting value of the display according to the optimum curve.

13. The apparatus according to claim 12, further comprising:
a timing checking unit for regularly checking a video player,
wherein the capturing unit captures the current frame, the optimum curve generating unit chooses the optimum curve, and the adjusting unit adjusts the gamma setting value of the display when the video player is executed.

14. The apparatus according to claim 12, wherein the optimum curve generating unit chooses one of the reference curves as the optimum curve according to a dark-spot ratio of the current frame.

15. The apparatus according to claim 12, wherein the reference curves are respectively built into a plurality of look-up tables.

16. The apparatus according to claim 12, wherein the reference curves are generated according to a high dynamic range (HDR) algorithm.

17. The apparatus according to claim 12, wherein the reference curves are generated according to a histogram equalization algorithm.

18. The apparatus according to claim 12, wherein the capturing unit captures the current frame through a graphical device interface (GDI).

19. The apparatus according to claim 12, wherein the capturing unit captures the current frame through DirectX.

20. The apparatus according to claim 12, wherein the capturing unit captures the current frame through a media application program interface (Media API).

21. The apparatus according to claim 12, wherein the adjusting unit adjusts the gamma setting value through a graphical device interface (GDI).

22. The apparatus according to claim 12, wherein the adjusting unit adjusts the gamma setting value through DirectX.
